(19) United States
(12) Patent Application Publication
(10) Pub. No.: US 2004/0152789 A1
(43) Pub. Date: Aug. 5, 2004

(54) Stable aqueous colloidal dispersion, method for preparing same

(76) Inventors: Jean-Yves Chane-Ching, Eaubonne (FR); Claude Magnier, Paris (FR); Albert Lebugle, Saint Orens (FR)

Correspondence Address: BURNS DOANE SWECKER & MATHIS L L P, POST OFFICE BOX 1404, ALEXANDRIA, VA, 22313-1404, US

(21) Appl. No.: 10/475,913

(22) PCT Filed: Apr. 25, 2002
(86) PCT No.: PCT/FR02/01441

(30) Foreign Application Priority Data
Apr. 27, 2001 (FR) 01/05749

(51) Int. Cl. B01F 17/00

(52) U.S. Cl. 516/40

(57) ABSTRACT

The invention concerns a stable aqueous colloidal dispersion of colloids with apatite structure, having a pH ranging between 5 and 10.5, comprising a bifunctionalised stabilising agent having a first amine or ammonium function and a second function capable of complexing calcium, and consisting of oblong colloids with an average number length ranging between 5 and 100 nm and an equivalent aspect ratio (number average length/equivalent diameter ratio) ranging between 2 and 300, said colloids with apatite structure corresponding to the formula: Ca₁₀₋ₓ(HPO₄)ₓ(PO₄)₆₋ₓ(J)₂₋ₓ, wherein x and J are such as defined in claim 1.

The present invention relates to stable aqueous colloidal dispersions of colloids possessing an apatite structure in which the colloids, of oblong shape, exhibit nanometric dimensions.

These colloids, in the more or less aggregated form, form objects of oblong shape with a (number-)average length (or greater dimension) of between 5 and 100 nm and with an equivalent aspect ratio of between 2 and 300.

The term “aqueous colloidal dispersion” is generally understood to mean a system composed of a continuous aqueous phase in which fine solid particles of colloidal size are dispersed, said fine particles defining colloids at the surface of which molecules of a stabilizing agent or of various ionic entities present in the continuous aqueous phase can be bonded or adsorbed.

The term “colloids possessing an apatite structure” is understood to mean, according to the invention, colloids of general formula:

Ca₁₀₋ₓ(HPO₄)ₓ(PO₄)₆₋ₓ(J)₂₋ₓ (I)

in which;

x is selected from 0, 1 or 2;

J is selected from OH⁻, F⁻, CO₃²⁻ and/or Cl⁻;

and in which some phosphate ions (PO₄³⁻) or hydrogenphosphate ions (HPO₄²⁻) can be replaced by carbonate ions (CO₃²⁻);

and in which some Ca²⁺ cations can be replaced by Mⁿ⁺ metal cations of alkali metals, alkaline earth metals or lanthanide metals where n represents 1, 2 or 3, it being understood that the molar ratio of the Mⁿ⁺ cation to Ca²⁺, when Mⁿ⁺ is present, varies between 0.01:0.99 and 0.25:0.75, and that the substitution of HPO₄²⁻ ions or of PO₄³⁻ ions by CO₃²⁻ ions, the incorporation of CO₃²⁻ ions as J and the substitution of Ca²⁺ cations by metal cations is carried out so as to satisfy the electronic balance, in particular with creation of gaps.

The expression “colloids possessing an apatite structure” also encompasses the colloids obtained by hydrolysis of the colloids of formula I above.

In the case of octocalcium phosphate, a colloid of formula Ca₈(HPO₄)_{2.5} (PO₄)_{3.5}OH_{0.5} is obtained after hydrolysis.

In a particular preferred way, when Ca²⁺ is replaced by an alkali metal cation, the latter is Na⁺. When Ca²⁺ is replaced by an alkaline earth metal cation, the latter is Sr²⁺.

When Ca²⁺ is replaced by a lanthanide cation, the latter is preferably Eu³⁺, Eu²⁺, Dy³⁺ or Tb³⁺.

More generally, “lanthanide” is understood to mean elements from the group consisting of yttrium and of the elements of the Periodic Table with an atomic number of between 57 and 71 inclusive.

The Periodic Table of the Elements to which reference is made in the present description is that published in the Supplement to the Bulletin de la Société Chimique de France, No. 1 (January 1966).

When x=0, the colloids are hydroxyapatite colloids. When x=1, the colloids are apatitic tricalcium phosphate colloids and, when x=2, the colloids are octocalcium phosphate colloids.

In the above formula, it is preferable for no Ca²⁺ cation to be replaced by an Mⁿ⁺ metal cation. However, when some Ca²⁺ cations are actually replaced by Mⁿ⁺ metal cations, then it is preferable for the Mⁿ⁺/Ca²⁺ molar ratio to vary between 0.02:0.98 and 0.15:0.85.

The colloids possessing an apatite structure are generally obtained by bringing into contact, in aqueous solution, a source of Ca²⁺ and a source of PO₄³⁻ in an appropriate pH range.

By conventional processes, there is obtained colloids with an apatite structure, the growth of which is difficult to control and limit.

The kinetics of formation of the particles are often very high, so that it is difficult to halt the inorganic polycondensation at the stage of nanometric particles. Thus, in fine, excessively large particles exhibiting a strong tendency to separate by settling are generally obtained.

The invention provides, according to a first of its aspects, a process which makes it possible to control the growth of colloids possessing an apatite structure and which results in stable colloidal dispersions composed of colloids of nanometric dimensions.

According to another aspect, the invention relates to stable aqueous colloidal dispersions of colloids possessing an apatite structure formed of relatively fine colloids, of oblong shape, with a (number-)average length of between 5 and 100 nm and with an equivalent aspect ratio (ratio of the (number-)average length to the equivalent diameter) of between 2 and 300. These dispersions are generally transparent due to the small dimensions of the colloids constituting them.

More specifically, the invention relates to a stable aqueous colloidal dispersion of colloids with an apatite structure, exhibiting a pH of between 5 and 10.5, comprising a bifunctionalized stabilizing agent exhibiting a first amine or ammonium functional group and a second functional group capable of complexing calcium, and formed of colloids of oblong shape with a (number-)average length of between 5 and 100 nm and with an equivalent aspect ratio (ratio of the (number-)average length to the equivalent diameter) of between 2 and 300, said colloids possessing an apatite structure having the formula

Ca₁₀₋ₓ(HPO₄)ₓ(PO₄)₆₋ₓ(J)₂₋ₓ (I)

in which;

x is selected from 0, 1 or 2;

J is selected from OH⁻, F⁻, CO₃²⁻ or Cl⁻;

and in which some phosphate ions (PO₄³⁻) or hydrogenphosphate ions (HPO₄²⁻) can be replaced by carbonate ions (CO₃²⁻);

and in which some Ca²⁺ can be replaced by Mn⁺ metal cations of alkali metals, alkaline earth metals or lanthanide metals where n represents 1, 2 or 3, it being understood that the molar ratio of the Mⁿ⁺ cation, when it is present, to Ca₂+ varies between 0.01:0.99 and 0.25:0.75, and that the substitution of HPO₄²− ions or of PO₄³⁺ ions by CO₃²⁻ ions, the incorporation of CO₃²⁻ ions as J and the substitution of Ca²⁺ cations by metal cations is carried out so as to satisfy the electronic balance.

In the context of the invention, the term “colloids of oblong shape” is understood to mean colloids of parallelepipedal shape (for example in the shape of a rod) or of acicular shape.

In the case of the colloids of parallelepipedal shape, the equivalent diameter is the diameter which the corresponding colloid of acicular shape with the same average volume and with the same average length would have.

The equivalent diameter assigned to the cross section of the acicular colloid corresponds to the diameter of an average cross section.

The colloids of oblong shape are formed of more or less aggregated colloids possessing an apatite structure.

The dimensions of the colloids vary according to the operating conditions employed during the preparation of said colloidal dispersions. In the event of weak aggregation of the colloids, the colloids of oblong shape exhibit a (number-)average length of between 5 and 100 nm and an equivalent diameter of between 0.5 and 5 nm.

In the event of greater aggregation, the colloids of oblong shape exhibit a (number-)average length of between 5 and 100 nm and an equivalent diameter of between 5 and 30 nm.

The colloids possessing apatite structures synthesized are preferably colloids of formula (I) in which x=0, better still colloids of formula: Ca₁₀(PO₄)₆(OH)₂.

More specifically, it is preferable, in the formula (I), for J to represent OH⁻ and/or F⁻. It is not necessary for all the OH⁻ ions to be replaced by F⁻ ions but only a portion of the OH⁻ ions may be replaced by F⁻ ions.

Likewise, when J is selected from OH⁻, F⁻, CO₃²⁻ and Cl⁻, it is not necessary for all the J groups to be identical to one another.

The colloidal dispersion is stabilized by the action of a stabilizing agent exhibiting a double functionality. The stabilizing agent contributes not only to stabilizing the dispersion but also to controlling the growth of the colloids possessing an apatite structure during the preparation of the aqueous dispersion. In order to provide this two-fold role, the stabilizing agent exhibits an amine or ammonium functional group and a functional group capable of complexing the Ca²⁺ cation. Advantageously, these two functional groups are grafted to a lipophilic part, such as a linear or branched, preferably C₂-C₁₈, better still C₂-C₁₂, alkylene chain.

According to a particularly preferred embodiment, the functional group capable of complexing Ca²⁺ is an optionally ionized phosphoric acid functional group (—O—P(O)(OH)₂), an optionally ionized phosphonic acid functional group (—P(O)(OH)₂ or —P(O)(OH)—O—) or an optionally ionized phosphinic acid functional group (HO—P(O)<).

Preferably, the stabilizing agent has the formula:

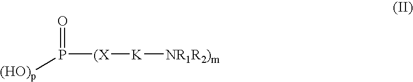

in which

p represents 1 or 2;

m represents 1 when p represents 2 and m represents 2 when p represents 1;

X represents —O— or a bond;

K represents an optionally substituted, linear or branched, C₂-C₁₀ alkylene group;

R₁ and R₂ independently represent a hydrogen atom or an optionally substituted, optionally aromatic, carbocyclic and/or aliphatic hydrocarbonaceous group; or else the stabilizing agent is an ionized form of a compound of formula (II).

Mention may be made, as example of inorganic acid, of nitric, phosphoric, phosphinic, phosphonic, hydrochloric, sulfonic and sulfuric acids.

Mention may be made, as example of inorganic base, of bases of alkali metal hydroxide, alkaline earth metal hydroxide and ammonium hydroxide type.

The term “alkylene” is understood to mean a linear or branched aliphatic hydrocarbonaceous chain.

Preferably, K is a C₂-C₅, better still C₂-C₃, alkylene group.

The substituents of the alkylene group representing K and of the hydrocarbonaceous group representing R₁, R₂ and/or R₃ are in particular halogen atoms, such as chlorine, bromine, fluorine or iodine, and more particularly chlorine.

The term “hydrocarbonaceous group” is understood to mean a group comprising from 1 to 18, preferably 1 to 12, carbon atoms.

The hydrocarbonaceous group can comprise an aliphatic part and/or an optionally aromatic carbocyclic part.

The term “aliphatic hydrocarbonaceous radical” is understood to mean an optionally substituted, saturated, linear or branched group preferably comprising from 1 to 18 carbon atoms.

Advantageously, said aliphatic hydrocarbonaceous group comprises from 1 to 12 carbon atoms, better still from 1 to 6 carbon atoms.

Examples thereof are alkyl radicals, such as the methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethyl-propyl, heptyl, 1-methylhexyl, 1-propylbutyl, 4,4-dimethylpentyl, octyl, 1-methylheptyl, 2-ethyl-hexyl, 5,5-dimethylhexyl, nonyl, decyl, 1-methylnonyl, 3,7-dimethyloctyl and 7,7-dimethyloctyl radicals.

More specifically, alkyl represents methyl, ethyl, propyl, isopropyl, butyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl and 1-methyl-1-ethylpropyl.

Preferably, the alkyl radical comprises from 1 to 4 carbon atoms and in particular ethyl.

The term “carbocyclic radical” is understood to mean, according to the invention, an optionally substituted, preferably C₃-C₅₀, monocyclic or polycyclic radical.

Preferably, it is a, preferably mono-, bi- or tricyclic, C₃-C₁₈ radical.

The carbocyclic radical can comprises a saturated part and/or an aromatic part.

When the carbocyclic radical comprises more than one ring (case of polycyclic carbocycles), the rings can be fused in pairs or attached in pairs via σ bonds.

Examples of saturated carbocyclic radicals are the cycloalkyl groups.

Preferably, the cycloalkyl groups are saturated, cyclic, preferably C₃-C₁₈, better still C₃-C₁₀, hydrocarbonaceous radicals and in particular the cyclopentyl, cyclohexyl, cycloheptyl, cyclooctyl, adamantyl or norbornyl radicals.

Examples of aromatic carbocyclic radicals are the (C₆-C₁₈)aryl groups and in particular phenyl, naphthyl, anthryl and phenanthryl.

When the hydrocarbonaceous group comprises both an aromatic part and an aliphatic part, the aromatic part and the aliphatic part are as defined above.

Examples of such groups are in particular the arylalkyl groups and, for example, (C₆-C₁₀)aryl(C₁-C₁₀)alkyl and the alkylaryl groups and, for example, (C₁-C₁₀)alkyl-(C₆-C₁₀) aryl.

A preferred subgroup of the stabilizing agents of formula (II) is composed of the agents of formula (II) in which p represents 2, m represents 1 and X represents an oxygen atom.

A particularly preferred stabilizing agent is O-phosphorylethanolamine of formula:

(OH)₂P(O)—CH₂—CH₂—NH₂.

The stabilizing agent is generally either present in the free form in the continuous medium of the colloidal dispersion, or adsorbed at or bonded to the surface of the colloids, or in interaction with Ca²⁺ ions present in the continuous phase.

The stabilizing agent can be constituted of one or more compounds of formula (I).

The colloidal phase predominantly possesses an apatite structure as defined above. Advantageously, the apatite structure represent more than 50% by weight of the colloidal phase, preferably more than 75% by weight, better still more than 80%, for example more than 85% by weight.

The colloidal phase can additionally comprise other calcium phosphate structures, such as Ca(H₂PO₄)₂; CaHPO₄; CaHPO₄.2H₂O, or other amorphous phases based on calcium and on PO₄³⁻, HPO₄²⁻ or H₂PO₄⁻ and OH⁻.

The Ca/P molar ratio in the colloidal phase generally varies between 1.2 and 1.7, better still between 1.4 and 1.67.

In addition, it is preferable for the molar ratio of the stabilizing agent to the calcium in the colloidal phase to be between 0.05 and 2.

The concentration of calcium in the dispersion can be easily adjusted, according to the invention, by removing a portion of the continuous aqueous phase.

The removal of a portion of the aqueous phase can be carried out by ultrafiltration.

However, preferably, the colloidal dispersion of the invention exhibits a concentration of calcium in the form of colloids possessing an apatite structure of greater than 0.25M, preferably of greater than 0.5M, advantageously of greater than 1M, it being possible for this concentration to reach 5M.

In a particularly preferred way, the colloidal phase comprises from 60 to 100% of the total calcium, for example from 80 to 100%, preferably from 90 to 100%, better still from 95 to 100%.

The remaining fraction of calcium cations is found in solution in the continuous medium of the dispersion.

Advantageously, the colloidal phase comprises from 60 to 100% of the total phosphorus, more preferably from 80 to 100% of the total phosphorus (total PO₄³⁻, HPO₄²⁻ and H₂PO₄⁻ ions), advantageously from 90 to 100%, better still from 95 to 100% by weight, the remaining fraction being found in solution in the continuous medium of the dispersion.

The term “inorganic phosphorus” is understood to mean the phosphorus present in the entities H₃PO₄, H₂PO₄⁻ and HPO₄²⁻ the phosphorus present in the stabilizing agent of formula (II) not being regarded as inorganic phosphorus.

According to a preferred form of the invention, the pH of the colloidal dispersion of the invention varies between 6 and 9.5.

According to a preferred form of the invention, the colloidal dispersion is transparent to the naked eye. Colloidal dispersions transparent to the naked eye are formed of well-separated, not very aggregated colloids. For these transparent dispersions, at least 80% by number of the colloids, preferably at least 90% and advantageously at least 95% by number, are not aggregated. This state of aggregation can be revealed by cryo-transmission electron microscopy, according to the Dubochet method. This method makes it possible to observe, by transmission electron microscopy (TEM), samples kept frozen in their natural medium, which is either water or organic diluents. Freezing is carried out on thin films with a thickness of approximately 50 to 100 nm, either in liquid ethane, for the aqueous samples, or in liquid nitrogen, for the others. The state of dispersion of the particles is well preserved by cryo-TEM and representative of that present in the real medium.

The term “poorly aggregated colloids” is understood to mean a percentage by number of completely separate objects of greater than 80%, preferably of greater than 90%, advantageously of greater than 95%.

For these transparent dispersions, the length of the colloids varies between 5 and 50 nm.

According to another of its aspects, the invention relates to a transparent aqueous colloidal dispersion formed of colloids of oblong shape with a (number-)average length of 5 to 50 nm, in which at least 80% of the colloids are not aggregated, the molar ratio of the stabilizing agent to the total calcium present in the colloids or at the surface of the colloids is between 0.05 and 2 and the ratio of the total calcium to the total phosphorus in the colloids is between 1.2 and 1.7, the pH of the colloidal dispersion being greater than 7.

According to another of its aspects, the invention relates to a process for the preparation of a stable aqueous colloidal dispersion comprising the stages consisting in:

a) bringing into contact, in aqueous solution, a source of Ca²⁺ cations, a source of PO₄³⁻ anions and a bifunctionalized stabilizing agent exhibiting a first amine or ammonium functional group and a second functional group capable of complexing calcium, at a pH of between 5 and 11, the respective amounts of the source of Ca²⁺ and of the source of PO₄³⁻ anions being such that the Ca²⁺/P molar ratio varies between 1 and 5, preferably between 2 and 4, the amount of stabilizing agent being such that the stabilizing agent/Ca molar ratio varies between 0.1 and 3, preferably between 0.2 and 2.5;

b) leaving the solution thus obtained to mature at a temperature of between 20 and 95° C. until a colloidal dispersion is obtained.

The term “source of Ca²⁺ cations” is understood to mean a compound capable of releasing Ca²⁺ ions in aqueous solution.

The term “source of PO₄³⁻ anions” is understood to mean a compound capable of releasing PO₄³⁻ anions in aqueous solution.

Examples of source of Ca²⁺ cations are calcium hydroxide, calcium oxides or calcium salts.

Examples of calcium salts are the salts having, as anion, PF₆⁻, PCl₆⁻, BF₄⁻, BCl₄⁻, SbF₆⁻, BPh₄⁻, ClO₄⁻, CF₃SO₃⁻ and more generally the carboxylates derived from C₂-C₁₀ alkylcarboxylic acids. Other salts are calcium halides, calcium carbonate, calcium hydrogencarbonate and calcium nitrate.

In a particularly preferred way, the source of Ca²⁺ cations is selected from calcium hydroxide, calcium chloride, calcium fluoride, calcium nitrate, calcium carbonate and calcium hydrogencarbonate.

By way of example, the source of PO₄³⁻ anions is the salt of a PO₄³⁻ anion, the salt of an HPO₄²⁻ anion or the salt of an H₂PO₄⁻ anion, such as an ammonium salt, an alkali metal salt or an alkaline earth metal salt.

These two sources have to be brought together under highly specific pH conditions in order to result in the formation of colloids possessing the desired apatite structure: generally, a pH of between 5 and 11, preferably between 5 and 10.5, better still between 6 and 9.5, is highly suitable.

After the two sources have been brought together in an aqueous medium, it may therefore prove to be necessary to adjust the pH of the aqueous medium by addition to this medium of an acid or of a base, preferably an inorganic acid or base.

The bases and acids which can be used are those generally used in the art.

Mention may be made, as bases which can be used, of NH₄OH, KOH, NaOH, NaHCO₃, Na₂CO₃, KHCO₃ and K₂CO₃.

Use will preferably be made of NH₄OH or NaOH.

Examples of acids which can be used are in particular HCl, H₂SO₄, H₃PO₄ or HNO₃.

The sources can be brought into contact in an aqueous medium in any way.

Preferably, it is recommended to prepare, in a first 2+step, an aqueous solution of the source of Ca²⁺, on the one hand, and an aqueous solution of the source of PO₄³⁻, on the other hand. The relative proportions of the compounds used respectively as source of Ca²⁺ and of PO₄³⁻ are calculated so that the Ca/P molar ratio is between 1 and 5, preferably between 2 and 4.

The Ca/P molar ratio takes into account all the Ca²⁺ cations introduced and all the phosphorus introduced into the solution, whether the phosphorus is in the H₃PO₄, H₂PO₄³⁻, HPO₄²⁻ or PO₄³⁻ form.

The stabilizing agent is then added, either to the aqueous Ca²⁺ solution or to the aqueous PO₄³⁻ solution or to both aqueous solutions, in which case the respective proportion of stabilizing agent added to each solution can take any value.

The amount of stabilizing agent to be added in total is defined so that the stabilizing agent/Ca molar ratio varies between 0.1 and 3, preferably between 0.2 and 2.5, for example between 0.2 and 1.5.

The stabilizing agent is preferably as defined above. It is preferably a compound of formula (II), more preferably still a compound of formula (II) in which p represents 2, m represents 1 and X represents an oxygen atom.

More advantageously still, the stabilizing agent is O-phosphorylethanolamine of formula

(OH)₂P(O)—CH₂—CH₂—NH₂.

After addition of the stabilizing agent, the two aqueous solutions are mixed, this mixing being carried out conventionally with stirring.

A preliminary adjustment of the pH of the two dispersions is preferably carried out before mixing. This pH is adjusted to between 5 and 11.

Preferably, the aqueous solution of the source of PO₄³⁻ is poured into the aqueous solution of the source of Ca²⁺ comprising the stabilizing agent.

After mixing, it may prove to be necessary to readjust the pH conditions of the solution under the conditions described above.

For the purpose of preparing colloids in which some of the calcium cations are replaced by metal cations, it is necessary to add one or more sources of said metal cations to the reaction medium. Appropriate sources are composed of the hydroxides of these metals or salts of these metals, such as the halides or nitrates.

In the case where the metal cation is the cation of a lanthanide, it is preferable to add a salt of said lanthanide to the reaction solution, such as a chloride or a nitrate. This salt will be added, for example, to the solution of the source of calcium before it is mixed with the source of PO₄³⁻.

The source of Ca²⁺ and the source of PO₄³⁻ are generally brought into contact at ambient temperature, for example between 15 and 30° C.

Stage b) of the process of the invention is a maturing stage during which the mixture of the two solutions is left standing or stirring, the time necessary to observe the formation of colloids.

This maturing stage can be carried out at ambient temperature (15-30° C.) or at a higher temperature, namely up to 95° C. Thus, generally, the temperature is set at this stage between 15 and 95° C., better still between 20 and 95° C., for example between 50 and 90°C.

The maturing stage is preferably carried out in a closed chamber.

The dispersion, conditioned in a closed chamber, can be placed directly in an oven brought beforehand to the set temperature or can be subjected to a temperature gradient up to the set temperature, the rate of temperature rise preferably varying between 0.1° C./min and 10° C./min.

According to another embodiment of the invention, the maturing is carried out at various temperatures.

Preferably, a first phase of the maturing is carried out between 20 and 95° C. at a first temperature and a second maturing phase is carried out at a second temperature, said second temperature also being between 20 and 95° C. Advantageously, said second temperature is greater than said first temperature.

The maturing time varies according to the operating conditions and more particularly the temperature. The maturing time usually varies between 0.5 and 24 hours, preferably between 2 and 16 hours.

The continuous phase of the colloidal dispersion can comprise various entities, such as NH₄⁺, Na⁺, K⁺, Cl⁻, NO₃⁻ and SO₄²⁻. These ions originate either from the sources of calcium and of PO₄³⁻ or from the inorganic acids and bases used for the pH adjustments.

The continuous phase of the colloidal dispersion can also comprise stabilizing agents, in the neutral form or in the ionized form, not in interaction with the surface of the colloids, that is to say completely free.

It is difficult to avoid the presence of various calcium or phosphorus entities and the presence of the stabilizing agent of formula (II) in the continuous aqueous phase or beside the colloids possessing an apatite structure, so that it may be necessary to wash the dispersion.

This washing operation can be carried out in a way conventional per se, by ultrafiltration.

Ultrafiltration can be carried out in particular under air or under an atmosphere of air and of nitrogen or under nitrogen. It is preferably carried out with water having a pH adjusted to the pH of the dispersion.

Depending on the situation, the dispersion can then also be concentrated by removing a portion of the continuous phase. The most appropriate technique for doing this is the ultrafiltration technique.

If appropriate, it is possible to carry out a post-adjustment of the pH after washing and concentrating by ultrafiltration. This final pH can advantageously be between 6 and 8.5.

It is preferable, so as to prepare transparent colloidal dispersions, to adjust one or more of the operating conditions in the following way:

a—molar ratio of the stabilizing agent to the calcium of greater than 0.6 in stage a);

b—molar ratio of the calcium to the total phosphorus of greater than 2, better still of greater than 3, in stage a);

c—pH of greater than 7, better still 8.5, in stage a);

d—maturing temperature in stage b) of greater than 40° C., better still of greater than 60° C.;

e—maturing time in stage b) of greater than 4 hours, better still of greater than 8 hours.

Preferably, all the characteristics a) to e) will be fulfilled.

The size of the colloids can be determined by photometric counting from an HRTEM (High Resolution Transmission Electron Microscopy) analysis. The structure of the colloids and in particular their greater or lesser degree of aggregation can be determined by cryo-transmission electron microscopy by following the Dubochet method.

The (number-)average length of the colloids of oblong shape varies between 5 and 100 nm and their equivalent aspect ratio (ratio of the (number-)average length to the equivalent diameter) varies between 2 and 300.

The dimensions of the colloids exhibiting a low degree of aggregation generally vary in the following proportions:

the (number-)average length varies between 5 and 100 nm, preferably between 5 and 80 nm;

the equivalent diameter varies between 0.5 and 5 nm.

The dimensions of the colloids exhibiting a higher degree of aggregation vary in the following proportions:

the (number-)average length varies between 5 and 100 nm, preferably between 5 and 80 nm;

the equivalent diameter varies between 5 and 30 nm.

The colloidal dispersions of the invention can be used in many applications, as they are or after isolation of the colloids possessing an apatite structure, for example for the purpose of forming porous materials.

The colloids can be isolated in a way known per se: simple evaporation at ambient temperature, evaporation under vacuum, evaporation at a temperature of greater than 100° C. or by ultracentrifugation.

Thus, according to another of its aspects, the invention relates to water-redispersible colloids possessing an apatite structure which can be obtained by carrying out the stages consisting in:

a) preparing a colloidal dispersion by employing the process described above;

b) isolating, in a way known per se and preferably by centrifuging, the colloids from the colloidal dispersion resulting from stage a).

The colloidal dispersions of the invention can also be used after preparation of an emulsion by addition of an oily phase.

Applicational examples of the colloidal dispersions or of the resulting porous materials are the separation and purification of proteins, use in prostheses and use in prolonged release systems.

In the pharmaceutical field, the hydroxyapatite colloids obtained can be used in the treatment of osteoporosis, cramp, colitis, bone fractures or insomnia and in dental hygiene.

The hydroxyapatite colloids can be used in the preparation of hydroxyapatite films, of absorbent materials with a high specific surface and with a high pore volume, of encapsulation materials and of catalytic materials, but also in the field of luminescence.

The colloids of the aqueous dispersions of the invention can be isolated simply by ultracentrifuging. These colloids can exhibit, bonded to or adsorbed at their surface, a certain amount of stabilizing agent. The amount of stabilizing agent present can be determined by chemical quantitative determination. The molar ratio of the stabilizing agent to the calcium of the colloid generally varies between 0.05 and 2, preferably between 0.1 and 1.

The invention is described more specifically below with reference to specific embodiments.

Each of the examples below illustrates the preparation of aqueous colloidal dispersions of hydroxyapatite colloids.

In the following, M denotes the molecular mass.

### EXAMPLE 1

A solution A is prepared by adding 3.2 g of Ca(NO₃)₂ (M=164.1 g/mol), i.e. 19.5 millimol, in 12 cm³ and 2.8 g of O-phosphorylethanolamine (M=141 g), i.e. 19.8 millimol, in 10 cm³ to a beaker and enough demineralized water is added to bring the volume up to 25 cm³ and the solution is stirred at ambient temperature. The pH is adjusted to 9 with concentrated aqueous ammonia.

The solution B is prepared by addition of 6.8 ml of a 0.96M phosphoric acid solution, i.e. 6.5 millimol, and enough demineralized water is added to bring the volume up to 25 cm³. The pH is adjusted to 9 with concentrated aqueous ammonia.

The solution B is added to the solution A instantaneously and at ambient temperature. The mixture is left stirring at ambient temperature for 15 min.

The mixture is transferred into a closed chamber and the mixture is placed in an oven brought beforehand to a temperature of 80° C. The duration of the temperature maturing is 16 hours.

A transparent colloidal dispersion is obtained having a calcium concentration of 0.4M.

Transmission electron microscopy by the cryo-TEM method reveals well-separated anisotropic colloids with an average length of approximately 15 nm and with an equivalent diameter of less than 2 nm.

### EXAMPLE 2

A solution A is prepared by adding 1.63 9 of Ca(NO₃) 2 (M=164.1 g/mol), i.e. 10 millimol, in 12 cm³ and 0.42 g of O-phosphorylethanolamine (M=141 g), i.e. 3 millimol, in 10 cm³ to a beaker and enough demineralized water is added to bring the volume up to 25 cm³ and the solution is stirred at ambient temperature. The pH is adjusted to 9 with concentrated aqueous ammonia.

The solution B is prepared by addition of 3.43 ml of a 0.96M phosphoric acid solution, i.e. 3.3 millimol, and enough demineralized water is added to bring the volume up to 25 cm³. The pH is adjusted to 9 with concentrated aqueous ammonia.

The solution B is added to the solution A instantaneously and at ambient temperature. The mixture is left stirring at ambient temperature for 15 min. The molar ratio R=(Ca:PO₄)=(3:1) and the molar ratio S=(PEA:Ca)=(0.3:1).

The mixture is transferred into a closed chamber and the mixture is placed in an oven brought beforehand to a temperature of 80° C. The duration of the temperature of maturing is 16 hours.

A colloidal dispersion is obtained having a calcium concentration of 0.2M.

The dispersion is then washed by ultrafiltration over a 3 kD membrane with four times its volume of demineralized water. A colloidal solution is obtained which is stable over time.

### EXAMPLE 3

A solution A is prepared by adding 20.35 g of Ca(NO₃)₂ (M=164.1 g/mol), i.e. 125 millimol, in 60 cm³ and 10.5 g of o-phosphorylethanolamine (M=141 g), i.e. 74.5 millimol, in 50 cm³ to a beaker and enough demineralized water is added to bring the volume up to 125 cm³ and the solution is stirred at ambient temperature. The pH is adjusted to 9 with concentrated aqueous ammonia.

The solution B is prepared by addition of 42.85 ml of a 0.96M phosphoric acid solution, i.e. 41 millimol, and enough demineralized water is added to bring the volume up to 125 cm³. The pH is adjusted to 9 with concentrated aqueous ammonia.

The solution B is added to the solution A instantaneously and at ambient temperature.

The total volume of concentrated aqueous ammonia used is 22.5 cm³. The mixture is left stirring at ambient temperature for 15 min. The molar ratio R=(Ca:PO₄)=(3:1) and the molar ratio S=(PEA:Ca)=(0.6:1).

The mixture is transferred into a closed chamber and the mixture is placed in an oven brought beforehand to a temperature of 80° C. The duration of the temperature maturing is 16 hours.

A bluish colloidal dispersion is obtained having a calcium concentration of 0.5M.

Tranmission electron microscopy reveals colloids formed by aggregation of 3 to 4 individual crystallites: the aggregate is of anisotropic form, with an average length of approximately 50 nm and with an equivalent diameter of approximately 10 nm.

The dispersion is then washed by ultrafiltration over a 3 kD membrane with four times its volume of demineralized water. A colloidal solution is obtained which is stable over time.

### EXAMPLE 4

A solution A is prepared by adding 1.63 g of Ca(NO₃)₂ (M=164.1 g/mol), i.e. 10 millimol, in 12 cm³ and 0.84 g of O-phosphorylethanolamine (M=141 g), i.e. 6 millimol, in 10 cm³ to a beaker and enough demineralized water is added to bring the volume up to 25 cm³ and the solution is stirred at ambient temperature. The pH is adjusted to 7 with concentrated aqueous ammonia.

A solution B is prepared by addition of 3.43 ml of a 0.96M phosphoric acid solution, i.e. 3.3 millimol, and enough demineralized water is added to bring the volume up to 25 cm³. The pH is adjusted to 7 with concentrated aqueous ammonia.

The solution B is added to the solution A instantaneously and at ambient temperature.

The mixture is left stirring at ambient temperature for 15 min. The molar ratio R=(Ca:PO₄)=(3:1) and the molar ratio S=(PEA:Ca)=(0.6:1).

The mixture is transferred into a closed chamber and the mixture is placed in an oven brought beforehand to a temperature of 80° C. The duration of the temperature maturing is 16 hours.

A colloidal dispersion is obtained having a calcium concentration of 0.2M.

A pellet is recovered by ultracentrifuging at 50 000 rev/min for 6 hours, which pellet is dried at ambient temperature.

Single-pulse and crossed polarization magic angle spinning ³¹P NMR reveals a major peak corresponding to a chemical shift of approximately 3 ppm assigned to hydroxyapatite. This hydroxyapatite phase is predominant and corresponds to more than 80% of the product.

Single-pulse proton NMR does not reveal protons belonging to organic chains of the complexing agent used.

Cryo-TEM reveals aggregates of anisotropic form, with an average length of 25 nm and with an equivalent diameter of approximately 5 nm.

### EXAMPLE 5

A solution A is prepared by adding 1.47 g of CaCl₂.2H₂O (M=147 g/mol), i.e. 10 millimol, in 12 cm³ and 1.41 g of O-phosphorylethanolamine (M=141 g), i.e. 10 millimol, in 10 cm³ to a beaker and enough demineralized water is added to bring the volume up to 25 cm³ and the solution is stirred at ambient temperature. The pH is adjusted to 7 with concentrated aqueous ammonia.

A solution B is prepared by addition of 3.3 ml of a 1M phosphoric acid solution, i.e. 3.3 millimol, and enough demineralized water is added to bring the volume up to 25 cm³. The pH is adjusted to 7 with concentrated aqueous ammonia.

The solution B is added to the solution A instantaneously and at ambient temperature.

The mixture is left stirring at ambient temperature for 15 min. The molar ratio R=(Ca:PO₄)=(3:1) and the molar ratio S=(PEA:Ca)=(1:1).

The mixture is transferred into a closed chamber and the mixture is placed in an oven brought beforehand to a temperature of 80° C. The duration of the temperature maturing is 16 hours.

A colloidal dispersion is obtained having a calcium concentration of 0.2M.

### EXAMPLE 6

A solution is prepared comprising 282 mg of O-phosphorylethanolamine (PEA), i.e. 2 mmol, in 20 ml of demineralized water. 2 mmol of calcium oxide, obtained by calcining 200 mg of CaCO₃ at 950° C. for 4 hours, are added with stirring. The solution becomes pearlescent. After stirring for 15 minutes, 5 ml of a solution comprising 2/3 mmol of orthophosphoric acid are added. A precipitate immediately forms. The pH is 7.7. The combined mixture is brought to 80° C. for 4 hours. The precipitate disappears and a slightly opalescent solution remains. Analysis by light scattering (Zetasizer) reveals an average dimension of the colloids of the order of 25 nm.

The ultracentrifuging of this solution results in a pellet and a supernatant, which are examined. After drying, the pellet appears, by X-ray diffraction, composed of an apatite. IR spectroscopy confirms the presence of a hydroxyapatite and, in a much smaller amount, of O-phosphorylethanolamine (PEA) (IR spectrum). Chemical analysis (quantitative determinations of the calcium, of the “inorganic” phosphorus, of the organic phosphorus, of the carbon and of the nitrogen) leads to the results presented in the following table:

| | | Inorganic | Organic | | |
|---|---|---|---|---|---|
| | Ca | (PO₄) | (PO₄) | C | N |
| Number | 0.72 | 0.43 | 0.11 | 0.23 | 0.11 |
| of mmol | | | | | |
| per 100 mg | | | | | |

The Ca/inorganic (PO₄) atomic ratio is equal to 1.66. The pellet is essentially composed of an apatite.

The supernatant was studied by ³¹P NMR and the spectrum compared with that obtained from a mixture of inorganic and organic phosphate, without Ca, in the starting proportions (PEA:PO₄)=(3:1). Whereas the spectrum of the mixture clearly shows the presence of two peaks which can assigned to the two phosphate entities, the spectrum of the supernatant only exhibits a single peak, corresponding to PEA. There is virtually no inorganic phosphate remaining any longer in the supernatant (³¹P NMR spectra).

The addition of ethanol to the supernatant results in the formation of a precipitate, which was analyzed (quantitative determinations of the calcium, of the “inorganic” phosphate, of the organic phosphate, of the carbon and of the nitrogen). It leads to the results presented in the following table:

| | | Inorganic | Organic | | |
|---|---|---|---|---|---|
| | Ca | (PO₄) | (PO₄) | C | N |
| Number | 0.29 | 0.02 | 0.57 | 1.2 | 0.6 |
| of mmol | | | | | |
| per 100 mg | | | | | |

The supernatant thus comprises essentially calcium and PEA in the ratio (Ca:PEA=1.2). It is composed of Ca(PEA)₂.

1. A stable aqueous colloidal dispersion of colloids with an apatite structure, exhibiting a pH of between 5 and 10.5, comprising a bifunctionalized stabilizing agent exhibiting a first amine or ammonium functional group and a second functional group capable of complexing calcium, and formed of colloids of oblong shape with a (number-)average length of between 5 and 100 nm and with an equivalent aspect ratio (ratio of the (number-)average length to the equivalent diameter) of between 2 and 300, said colloids possessing an apatite structure having the formula
Ca₁₀₋ₓ(HPO₄)ₓ(PO₄)₆₋ₓ(J)₂₋ₓ (I)
in which;
x is selected from 0, 1 or 2;
J is selected from OH⁻, F⁻, CO₃²⁻ or Cl⁻;
and in which some phosphate ions (PO₄³⁻) or hydrogenphosphate ions (HPO₄²⁻) can be replaced by carbonate ions (CO₃²⁻)
and in which some Ca²⁺ can be replaced by Mⁿ⁺ metal cations of alkali metals, alkaline earth metals or lanthanide metals where n represents 1, 2 or 3,
it being understood that the molar ratio of the m”+cation, when it is present, to Ca²⁺ varies between 0.01:0.99 and 0.25:0.75, and that
the substitution of HPO₄²⁻ ions or of PO₄³⁻ ions by CO₃²⁻ ions, the incorporation of CO₃²⁻ ions as J and the substitution of Ca²⁺ cations by metal cations is carried out so as to satisfy the electronic balance.

2. The colloidal dispersion as claimed in claim 1, characterized in that x represents 0.

3. The colloidal dispersion as claimed in claim 1, formed of apatite colloids of formula: Ca₁₀(PO₄)₆(OH)₂.

4. The colloidal dispersion as claimed in any one of claims 1 to 3, characterized in that the bifunctionalized stabilizing agent has the formula (II): 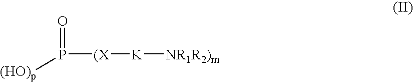
in which
p represents 1 or 2;
m represents 1 when p represents 2 and m represents 2 when p represents 1;
X represents —O— or a bond;
K represents an optionally substituted, linear or branched, C₂-C₁₀ alkylene group;
R₁ and R₂ independently represent a hydrogen atom or an optionally substituted, optionally aromatic, carbocyclic and/or aliphatic hydrocarbonaceous group;
or else the stabilizing agent is an ionized form of a compound of formula (II).

5. The colloidal dispersion as claimed in claim 4, characterized in that the stabilizing agent is such that, in the formula II, p represents 2, m represents 1 and X represents an oxygen atom.

6. The colloidal dispersion as claimed in claim 5, characterized in that the stabilizing agent has the formula:

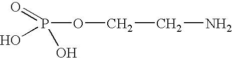

7. The colloidal dispersion as claimed in any one of claims 1 to 6, formed of colloids of oblong shape with an average length of between 5 and 100 nm and exhibiting an equivalent diameter of between 0.5 and 5 nm.

8. The colloidal dispersion as claimed in any one of claims 1 to 6, formed of colloids of oblong shape with an average length of between 5 and 100 nm and exhibiting an equivalent diameter of between 5 and 30 nm.

9. The colloidal dispersion as claimed in any one of the preceding claims, exhibiting a concentration of calcium in the form of colloids possessing an apatite structure of greater than 0.25M, preferably of greater than 0.5M.

10. The colloidal dispersion as claimed in any one of the preceding claims, in which the molar ratio of the stabilizing agent to the calcium in the colloidal phase varies between 0.05 and 2.

11. A process for the preparation of a stable aqueous colloidal dispersion comprising the stages consisting in:
a) bringing into contact, in aqueous solution, a source of Ca²⁺ cations, a source of PO₄₃ anions and a bifunctionalized stabilizing agent exhibiting a first amine or ammonium functional group and a second functional group capable of complexing calcium, at a pH of between 5 and 11, the respective amounts of the source of Ca²⁺ and of the source of PO₄³⁻ anions being such that the Ca²⁺/P molar ratio varies between 1 and 5, preferably between 2 and 4, the amount of stabilizing agent being such that the stabilizing agent/Ca molar ratio varies between 0.1 and 3, preferably between 0.2 and 2.5;
b) leaving the solution thus obtained to mature at a temperature of between 20 and 95° C. until a colloidal dispersion is obtained.

12. The process as claimed in claim 11, characterized in that the temperature is maintained between 50 and 90° C. in stage b).

13. The process as claimed in either one of claims 11 and 12, characterized in that the solution obtained on conclusion of stage b) is concentrated by ultrafiltration.

14. The process as claimed in any one of claims 11 to 13, characterized in that the bifunctionalized stabilizing agent is as defined in any one of claims 4 to 6.

15. The process as claimed in any one of claims 11 to 14, characterized in that, in stage a), the source of Ca²⁺ and of PO₄³⁻ are brought into contact by mixing an aqueous solution of a source of PO₄³⁻ with an aqueous solution of a source of Ca²⁺ comprising the stabilizing agent.

16. The process as claimed in any one of claims 11 to 15, characterized in that the stabilizing agent has the formula: 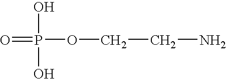
and in that the pH is adjusted to between 5 and 11 by addition of an inorganic base selected from NH₄OH, KOH, NaOH, NaHCO₃, Na₂CO₃, KHCO₃ and K₂CO₃, preferably NH₄OH.

17. The process as claimed in any one of claims 11 to 16, characterized in that the source of calcium is selected from calcium hydroxide, calcium oxides, calcium halides, calcium carbonate and calcium hydrogencarbonate.

18. The process as claimed in claim 17, characterized in that the source of calcium is selected from calcium nitrate, calcium chloride, calcium fluoride, calcium carbonate, calcium hydrogencarbonate and calcium hydroxide.

19. The process as claimed in any one of claims 11 to 18, characterized in that the source of PO₄³⁻ is selected from the salts of the PO₄³⁻, H₂PO₄^{—} or HPO₄²⁻ anions, such as the alkali metal salts, alkaline earth metal salts and ammonium salts.

20. The process as claimed in any one of claims 11 to 19, characterized in that the pH is adjusted to between 6 and 9.5 in stage a).

21. A water-redispersible colloid possessing an apatite structure which can be obtained by carrying out the stages consisting in:
a) preparing a colloidal dispersion by employing the process as claimed in any one of claims 11 to 20;
b) isolating the colloid from the colloidal dispersion resulting from stage a).

22. The process as claimed in claim 11 for the preparation of a transparent colloidal dispersion, characterized in that one or more of the following conditions are fulfilled:
a) the molar ratio of the stabilizing agent to the calcium in stage a) is greater than 0.6;
b) the molar ratio of the calcium to the total phosphorus is greater than 2, better still greater than 3, in stage a);
c) the pH is kept above 7, better still above 8.5, in stage a);
d) the maturing temperature is greater than 40° C., better still greater than 60° C., in stage b);
e) the maturing time is greater than 4 hours in stage b), better still greater than 8 hours.

23. The process as claimed in claim 22, characterized in that the conditions a) to e) are fulfilled.

24. The transparent colloidal dispersion as claimed in claim 1, characterized in that it can be obtained by employing the process as claimed in either one of claims 22 and 23.

25. The transparent aqueous colloidal dispersion as claimed in claim 1, characterized in that it is formed of colloids of oblong shape with a (number-)average length of 5 to 50 nm, in which at least 80% of the colloids are not aggregated, the molar ratio of the stabilizing agent to the total calcium present in the colloids or at the surface of the colloids is between 0.05 and 2 and the ratio of the total calcium to the total phosphorus in the colloids is between 1.2 and 1.7, the pH of the colloidal dispersion being greater than 7.
